(19) United States
(12) Patent Application Publication
(10) Pub. No.: US 2019/0367360 A1
(43) Pub. Date: Dec. 5, 2019

(54) SODIUM HYPOCHLORITE PENTAHYDRATE CRYSTAL GRAINS HAVING HIGH BULK DENSITY AND METHOD FOR PRODUCING SAME

(71) Applicant: Nippon Light Metal Company, Ltd., Tokyo (JP)

(72) Inventors: Hideo SHIMAZU, Shizuoka (JP); Tomohide OKADA, Shizuoka (JP); Tomotake ASAWA, Shizuoka (JP); Hiromichi ITO, Shizuoka (JP); Yukihiro SUGIYAMA, Tokyo (JP); Kaoru SHIMADA, Tokyo (JP)

(21) Appl. No.: 16/481,725

(22) PCT Filed: Jan. 30, 2018
(86) PCT No.: PCT/JP2018/003044

§ 371 Date: Jul. 29, 2019

(30) Foreign Application Priority Data
Feb. 2, 2017 (JP) 2017-017784

(51) Int. Cl. C01B 11/06; B01D 9/02

(52) U.S. Cl. CPC C01B 11/062; B01D 9/02

(57) ABSTRACT

Provided are sodium hypochlorite pentahydrate crystal gains that have high bulk density and increase bulk density in a container and improve transport efficiency by controlling the shape of the sodium hypochlorite pentahydrate crystals, and a production method thereof.

As a result of stirring or circulating by pump an aqueous solution of sodium hypochlorite pentahydrate in a crystallization tank in a crystallization step, sodium hypochlorite pentahydrate crystal grains are obtained having an average aspect ratio of 2.5 or less.

### FIELD

The present invention relates to sodium hypochlorite pentahydrate crystal grains and a method for producing the same.

### BACKGROUND

Sodium hypochlorite is typically available commercially as an aqueous solution having a mass-based concentration of 5% by mass to 13% by mass (effective chlorine concentration: 5% to 12%), and since it is superior in terms of bactericidal and bleaching effects, is used as a bactericide for use in water and sewage system, hot springs facilities, pools, food production and household use and as a bleaching agent for food production, the papermaking industry and the textile industry. In addition, it is also used in slime cleaning agent applications for preventing problems attributable to slime generated in plant cooling water circulation systems of various plants, circulating water or wastewater treatment and the like (e.g. problems such as decreases in thermal efficiency or obstruction of flowing water pipes due to the generation of slime by algae or bacteria and the like). These bactericidal and bleaching effects of sodium hypochlorite arise from the oxidation power thereof, and this oxidation power is used not only in the field or organic synthesis, but also in the production of a wide range of food additives, electronic materials, pharmaceuticals, agricultural chemicals and the like.

Although sodium hypochlorite is widely used in a diverse range of applications in this manner, in the case of carrying out oxidation reactions in the field of organic synthesis on an industrial scale, typical aqueous sodium hypochlorite solutions have shortcomings such as having low volumetric efficiency, poor productivity and generate a large amount of by-product wastewater. Although these problems are thought to be able to be solved through the use of a highly concentrated aqueous sodium hypochlorite solution, since aqueous sodium hypochlorite solutions proceed to rapidly decompose at normal temperatures the higher the concentration, concentrations of 13% or higher are not commercially available in Japan.

On the other hand, solid sodium hypochlorite crystals are known and the existence of monohydrates, 2.5 hydrates pentahydrates and hexahydrates have been reported (1998 Soda Handbook, p. 361). Among these hydrates, sodium hypochlorite pentahydrate has a theoretical sodium hypochlorite mass-based concentration of 45%, which is about three times higher than sodium hypochlorite solution, and since this offers the advantages of considerably decreasing transport volume and significantly reducing transport costs in comparison with typical aqueous sodium hypochlorite solutions, various synthesis examples and application examples have been reported thus far.

For example, PTL1 discloses a method for producing sodium hypochlorite pentahydrate industrially and examples of reducing the content of sodium chlorate contained in sodium hypochlorite pentahydrate are known in PTL2. PTL3 describes a method for producing a slurry solution containing sodium hypochlorite pentahydrate in which the effective chlorine content is about 25% to 40%.

The crystal forms of the conventional sodium hypochlorite pentahydrates described in these documents are all described as being needle crystals having a large aspect ratio (having the form of long needles). For example, the sodium hypochlorite pentahydrates obtained in the examples of PTL1 are all stated as containing needle crystals having a high aspect ratio of 1.7 to 10.

In addition, paragraph [0081] of PTL2 states that needle crystals are obtained having a ratio of the long axis to the short axis of 8 or more.

As is described in paragraph [0008] of PTL3, sodium hypochlorite pentahydrate most frequently forms needle crystals. Sodium hypochlorite compositions made only from sodium hypochlorite pentahydrate crystals are such that the needle crystals having a high aspect ratio ends up being arranged randomly, and since containers cannot be densely packed as a result thereof, there are problems in the manner of low bulk density, low transport efficiency and low storage efficiency.

Although crystals having a low aspect ratio can be produced by introducing a step for grinding down the crystals into a conventional production process in order to lower the aspect ratio of needle crystals, it becomes difficult to increase bulk density if, for example, the crystals are pulverized excessively so that the minor axis is 100 μm or less by subjecting to powerful pulverization. In addition, in the case of introducing such as pulverization step in this manner, it becomes necessary to purchase a pulverizer or other such equipment, which not only increases time and labor, but also results in the possibility of the sodium hypochlorite pentahydrate being decomposed by frictional heat and so forth during pulverization, thereby making it difficult to consider this to be a realistic approach. Although PTL3 attempts to solve these problems by creating an aqueous sodium hypochlorite solution slimy containing sodium hypochlorite pentahydrate in order to solve the problem of bulk density, this methods results in unnecessary sodium chloride, sodium chlorate and sodium hydroxide being contained at the time of use, resulting in the problem of these components ending up affecting the reaction.

### CITATION LIST

### Patent Literature

[PTL1] Japanese Unexamined Patent Publication No. 2000-290003

[PTL2] Japanese Unexamined Patent Publication No. 2014-169215

[PTL3] Japanese Translation of PCT International Application Publication No. 2015-533775

[PTL4] Japanese fnexamined Patent Publication No. H11-255503

### SUMMARY

### Technical Problem

An object of the present invention is to provide sodium hypochlorite pentahydrate crystal grains that have high bulk density and increase bulk density in a container and improve transport efficiency by controlling the shape of the crystal grains of the sodium hypochlorite pentahydrate, and a production method thereof.

### Solution to Problem

As a result of conducting extensive studies to solve the aforementioned problems, the inventors of the present invention found that, crystal grains of sodium hypochlorite pentahydrate can be produced that have a low aspect ratio, high bulk density and a nearly spherical shape by growing the crystals while pulverizing the crystals that precipitate when crystallizing sodium hypochlorite pentahydrate without increasing the number of production steps in the conventional method for producing sodium hypochlorite pentahydrate, thereby leading to completion of the present invention.

Namely, the present invention has the following configurations for the gist thereof.

(1) Sodium hypochlorite pentahydrate crystal grains having an average aspect ratio of 2.5 or less and an average minor axis of 0.1 mm to 1.5 mm.

(2) The sodium hypochlorite pentahydrate crystal grains described in (1) above, wherein bulk density is 0.80 g/cm³ or more.

(3) Sodium hypochlorite pentahydrate crystal grains having a bulk density of 0.80 g/cm³ or more.

(4) A method for producing sodium hypochlorite pentahydrate crystal grains comprising:

a first step for introducing chlorine into a 40% by mass to 48% by mass aqueous sodium hydroxide solution and chlorinating at a reaction temperature of 15° C. to 32° C.;

a second step for separating and removing by-product sodium chloride crystals that have precipitated and recovering an aqueous sodium hypochlorite solution having a sodium hypochlorite concentration of 24% by mass to 34% by mass;

a third step for cooling the aqueous solution containing sodium hypochlorite pentahydrate recovered in the second step to a cooling temperature of 0° C. to 26° C. in a crystallization tank integrating a condenser and a crystallizer to precipitate sodium hypochlorite pentahydrate, wherein the aqueous solution in the tank is stirred or circulated with a pump or stirred and circulated with a pump; and,

a fourth step for liquid-solid separating of the sodium hypochlorite pentahydrate crystals precipitated in the third step to obtain sodium hypochlorite pentahydrate crystal grains.

(5) The production method described in (4) above, wherein the stirring in the third step is carried out at an impeller tip speed of 2.1 m/sec to 7.5 m/sec.

(6) The production method described in (4) above, wherein the pump circulation in the third step is carried out by circulating an amount of liquid equal to 0.5 times to 4 times the amount of aqueous solution in the circulation tank in one hour.

(7) The production method described in (4) above, wherein the pump circulation in the third step is carried out by circulating an amount of liquid equal to 0.5 times to 4 times the amount of aqueous solution in the circulation tank in one hour and stirring at an impeller tip speed of 2.1 m/sec to 7.5 m/sec.

### Advantageous Effects of Invention

The rounded sodium hypochlorite pentahydrate crystal grains having a low aspect ratio of the present invention have high bulk density and significantly improve the amount thereof capable of being packed into a bag or container, or in other words, volumetric efficiency in comparison with those of the prior art. As a result, improved transport efficiency and reductions in the number of containers and so forth used can be achieved by reducing volume during transport in comparison with aqueous sodium hypochlorite solution or conventionally produced sodium hypochlorite pentahydrate crystals.

### BRIEF DESCRIPTION OF DRAWINGS

FIG. 1 indicates a digital photomicrograph of the sodium hypochlorite pentahydrate crystal grains of the present invention of Example 1.

FIG. 2 indicates a digital photomicrograph of the sodium hypochlorite pentahydrate crystal grains of the present invention of Example 2.

FIG. 3 indicates a digital photomicrograph of sodium hypochlorite pentahydrate crystal grains of Comparative Example 1.

FIG. 4 indicates a digital photomicrograph of sodium hypochlorite pentahydrate crystal grains of Comparative Example 2.

FIG. 5 indicates a digital photomicrograph of sodium hypochlorite pentahydrate crystal grains of Comparative Example 3.

FIG. 6 indicates the distribution of the aspect ratios of sodium hypochlorite pentahydrate crystal grains of Example 1.

FIG. 7 indicates the distribution of the aspect ratios of sodium hypochlorite pentahydrate crystal grains of Example 2.

FIG. 8 indicates the distribution of the aspect ratios of sodium hypochlorite pentahydrate crystal grains of Comparative Example 1.

FIG. 9 indicates the distribution of the aspect ratios of sodium hypochlorite pentahydrate crystal grains of Comparative Example 2.

FIG. 10 indicates the distribution of the aspect ratios of sodium hypochlorite pentahydrate crystal grains of Comparative Example 3.

FIG. 11 is a schematic diagram of the aspect ratio of a sodium hypochlorite pentahydrate crystal.

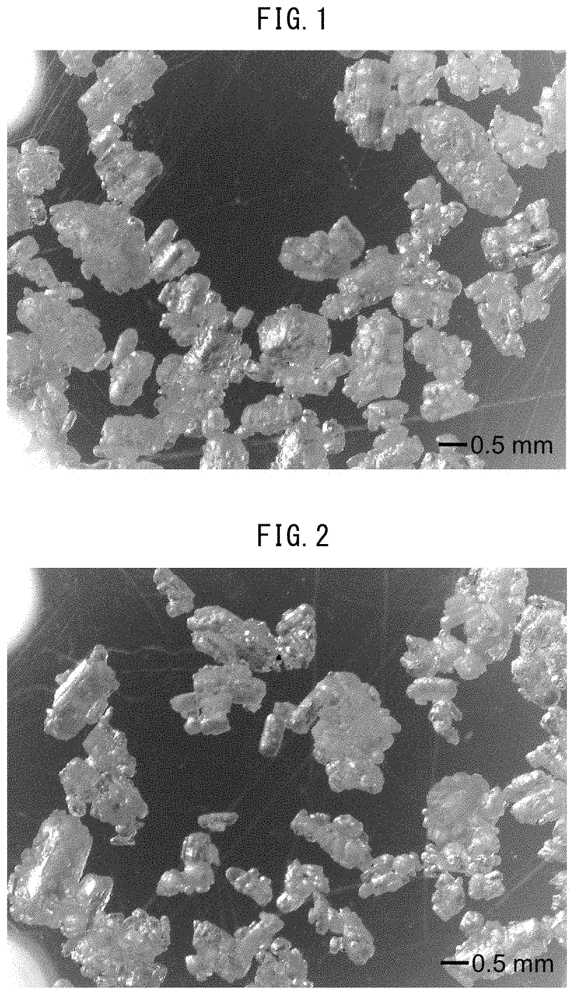

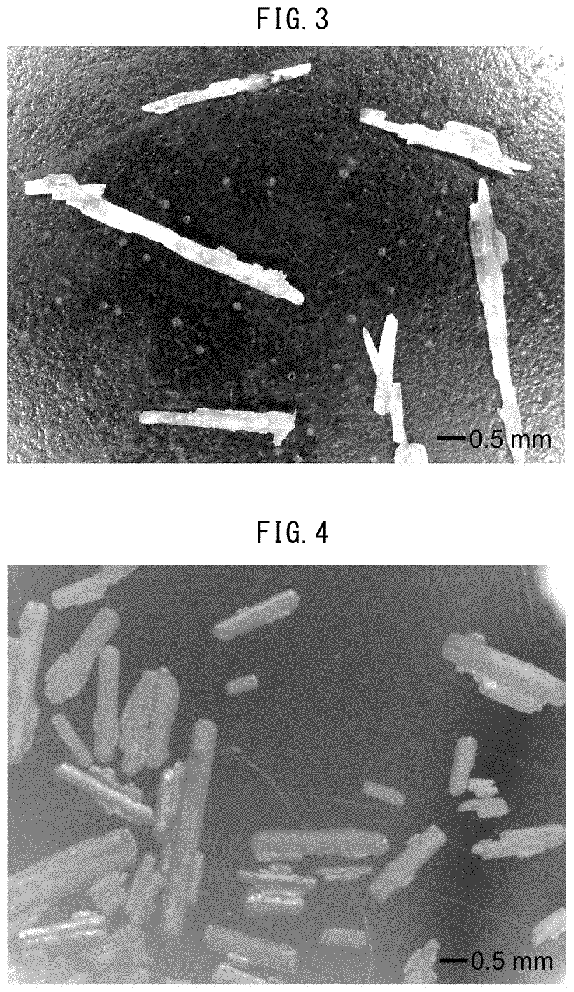

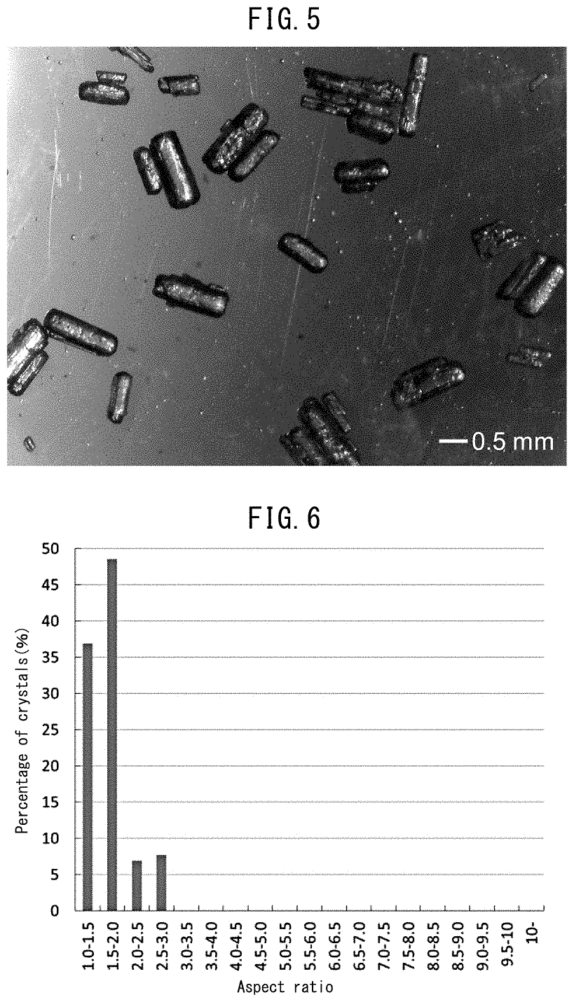

### DESCRIPTION OF EMBODIMENTS

The present invention provides sodium hypochlorite pentahydrate crystal grains, which are capable of enhancing volumetric efficiency during transport since the sodium hypochlorite pentahydrate crystal grains have a nearly spherical shape in which the average aspect ratio of the sodium hypochlorite pentahydrate crystal grains is 2.5 or less and the bulk density thereof is 0.80 g/cm³ or more, and a method for producing the same.

### Measurement of Average Aspect Ratio

The average value of the aspect ratio of the rounded sodium hypochlorite pentahydrate crystal grains of the present invention as represented by the ratio (L/S) of the long axis L to the short axis S of the grains is within a range of 1≤L/S≤2.5 when measured using an image obtained from a digital microscope (Hidemicron 3, Tec Co., Ltd.). Since the higher the bulk density the smaller the aspect ratio, the aspect ratio is more preferably within the range of 1.0≤L/S≤2.3 and even more preferably within the range of 1.0≤L/S≤2.0. This target substance of the present invention in the form of sodium hypochlorite pentahydrate crystal grains indicates that bulk density improves considerably in comparison with conventional crystal grains when packed into a container as a finished product.

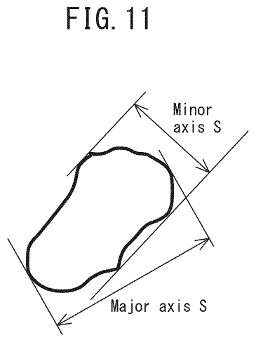

In the present invention, aspect ratio is determined as the ratio of the long axis (L) to the short axis (S) of the crystal grains (to be referred to as the L/S ratio). Furthermore, as shown in FIG. 11, the short axis refers to the short side of a rectangle in which the length of one side of a circumscribed rectangle, having an observed image of the grains targeted for measurement as the target region thereof, is the minimum. On the other hand, the long axis refers to the long side of a rectangle in which the length of one side of a circumscribed rectangle of the aforementioned target region is the maximum. These axes can typically be measured using available image analysis software (such as “Image-J”). The value of the average aspect ratio is determined by measuring the aspect ratios (L/S) of 300 or more grains according to the aforementioned method and calculating the quantitative average thereof. In addition, average minor axis is calculated as the quantitative average of S. However, crystal grains having a short axis of 0.01 mm or less that cannot be observed with a digital microscope are not taken into consideration in the content of the present invention.

The rounded sodium hypochlorite pentahydrate crystal grains of the present invention are given a nearly round shape in which the comers have been removed by circulating and/or stirring in a crystallization tank during crystallization of sodium hypochlorite pentahydrate. As a result, the angle of repose of the powder is 60 degrees or less, which is within a range that does not present a problem when loading raw materials. In addition, in the case of using a pump, if circulation by a powerful pump is excessively strong, the crystal grains that have grown end up collapsing, and since this results in the formation of fine crystals of 0.1 mm or less and lowering of bulk density, it is preferable to form crystals having an average minor axis length of 0.1 mm to 1.5 mm by controlling the circulation flow rate of the pump. The size of the crystal grains in terms of average minor axis length is more preferably 0.3 mm to 0.7 mm.

### Measurement of Bulk Density

Bulk density was measured as tamped density in the present invention. More specifically, after packing the sample into a standard container using a standard method in accordance with JIS R 9301-2-3:1999 (Alumina Powder—Part 2: Determination of Physical Properties-3: Untamped Density and Tamped Density), the cylinder containing the sample is dropped 100 times from a height of about 30 mm to compress the powder followed by calculating the bulk density from the mass and volume of the sample after compression.

### Measurement of Angle of Repose

Angle of repose was specifically calculated in accordance with JIS R 9301-2-2 (Alumina Powder—Part 2: Determination of Physical Properties-2: Angle of Repose).

The method for producing sodium hypochlorite pentahydrate crystal grains of the present invention includes a chlorination step (first step), a sodium chloride separation step (second step), a crystallization step (third step) and a solid-liquid separation step (fourth step). However, the production method is not limited to the first to fourth steps, but rather other steps may be inserted into the production method. For example, a step may be inserted for recycling a portion of the liquid separated in the second step and the separated liquid obtained in the fourth step to the chlorination step. Sodium hydroxide can also be added to enhance crystallization effects. The following provides a detailed explanation of each step.

### Chlorination Step (First Step)

In the chlorination step, aqueous sodium hydroxide solution and chlorine gas are allowed to react to obtain an aqueous sodium hypochlorite solution. Although the reaction step of the present invention may be batch treatment or continuous treatment, the sodium hydroxide and chlorine are preferably supplied continuously in order to coarsen the sodium chlorine granules and enhance productivity. Although the reaction tank may consist of a single tank, a continuous tank reactor is preferably provided in which multiple tanks such as two or three tanks are coupled to allow the chlorine to react by being supplied to each reaction tank in order to prevent the formation of sodium chlorate attributable to localized heat due to contact with the chlorine. In addition, although chlorine gas may be supplied directly to the reaction, localized heat generation can be suppressed by supplying after diluting with nitrogen or air. The raw material aqueous sodium hydroxide solution preferably uses that having a concentration of 40% by mass to 48% by mass, and although there are no particular limitations on the reaction temperature, it is preferably 15° C. to 32° C. If the reaction temperature is within this range, formation of sodium chlorate and the like accompanying a disproportionation reaction can be suppressed and sodium hypochlorite pentahydrate crystal grains can be produced that have few impurities. More specifically, it is preferable to obtain a sodium hypochlorite reaction solution by the production method described in PTL4. In the reaction step, chlorination proceeds until the sodium hypochlorite concentration becomes 23% by mass to 27% by mass, the sodium chloride concentration becomes 22% by mass to 27% by mass, and the sodium hydroxide concentration becomes 1.0% by mass to 2.0% by mass. The finished liquid is a slurry in which the supersaturated portion of the sodium chloride has precipitated.

### Sodium Chloride Separation Step (Second Step)

In the sodium chloride separation step, the liquid resulting from solid-liquid separation of sodium chloride from the finished chlorination liquid is used as a mother liquor in the subsequent crystallization step. More specifically, the aqueous sodium hypochlorite solution formed following chlorination contains a large amount of by-product sodium chloride crystals. Therefore, solid-liquid separation is carried out in the sodium chloride separation step by, for example, a centrifuge or filtration machine, although not particularly limited thereto. The resulting filtrate is preferably precooled when sending to the crystallization device of the subsequent step. Precooling is carried out for the purpose of reducing the amount of heat removed in the crystallization tank of the subsequent step, and the filtrate temperature is made to preferably be within +2° C. of the crystallization starting temperature and more preferably within 0° C. to +1° C. of the crystallization starting temperature. If the precooling temperature is equal to or lower than the crystallization starting temperature, crystals end up precipitating within the heat exchanger resulting in increased susceptibility to line freezing. More specifically, solid-liquid separation is preferably carried out according to the production method described in PTL4 to obtain an aqueous sodium hypochlorite solution (mother liquor).

Based on the relationship with the efficiency of the crystallization carried out in the subsequent step, the concentration of the aqueous sodium hypochlorite solution following separation of sodium chloride is preferably 24% by mass or more and more preferably 30% by mass to 34% by mass. In the case of this concentration exceeding 34% by mass, the aqueous sodium hypochlorite solution ends up scaling on the surface of the condenser as a result of becoming supersaturated, thereby inviting worsening of heat transfer efficiency.

### Crystallization Step (Third Step)

In the crystallization step, the aqueous sodium hypochlorite solution (mother liquor) obtained in the second step is introduced into a crystallization device and subjected to crystallization. Although there are no particular limitations on the crystallization tank, a tank-type crystallization device is preferable and the crystallization device is preferably provided with a pump and condenser to circulate liquid within the crystallization tank. Soft water may be added to the separated sodium hypochlorite obtained in the previous step as necessary to adjust the concentration of the sodium hypochlorite. Although there are no particular limitations on the diluted concentration, based on the relationship with crystallization efficiency, the concentration of the aqueous sodium hypochlorite solution is preferably 28% or more and more preferably 28% to 34%.

After having adjusted the concentration by diluting, the separated liquid is cooled in the subsequent crystallization step to obtain sodium hypochlorite pentahydrate. In the case of carrying out this procedure by batch treatment, although there are no problems even if seed crystal is not added, seed crystal is preferably added to control crystal shape.

In the case of adding seed crystal, the seed crystal is preferably added to the mother liquor for which the temperature has been adjusted to within ±2° C. at which sodium hypochlorite pentahydrate and sodium chlorate do not precipitate even if seed crystal is added to the mother liquor. More specifically, seed crystal is preferably added when the cooling starting temperature (mother liquor temperature) is within the range of 10° C. to 26° C. In the case of continuous treatment, the mother liquor is added continuously while cooling in the presence of seed crystal. When considering that the seed crystal dissolves slightly by the time crystallization occurs, the cooling starting temperature when the seed crystal is added is preferably within the range of 12° C. to 24° C. and more preferably within the range of 16° C. to 24° C. Crystals of sodium hypochlorite pentahydrate serving as seed crystal were added at a seed addition ratio Cs=0.04 to 0.08 (Cs=Ws/Wth; Ws: amount of seed, Wth: theoretical precipitated amount). At this time, although there are no particular problems even if seed crystals are not added, a small amount of seed crystal can be used in the manner described above for the purpose of suppressing the occurrence of crystallization on the sides of the crystallization tank walls and increasing crystallization rate.

In the production method of the present invention, although there are no particular limitations on the crystallization temperature, cooling may be carried out at a constant temperature and constant cooling rate. In the case of cooling at a constant cooling rate, the cooling rate is preferably 1° C./hr to 4° C./hr. In the case of this set rate, not only can adherence of crystal scales to the walls of the crystallization tank and worsening of drainability during increases in stirring power and solid-liquid separation caused by the formation of fine crystals be prevented, but also the mother liquor can be cooled without affecting productivity.

In the production method of the present invention, it is important to either stir the inside of the crystallization tank or circulate the liquid in the crystallization tank with a pump in the crystallization step. Pump circulation or stirring may be carried out separately or carried out in combination. Although there are no particular limitations on the type of pump, a rotary pump and the like is preferable. At this time, the crystallized crystals of sodium hypochlorite pentahydrate having a high aspect ratio are pulverized within the pump resulting in the formation of nearly spherical, fine grains. Due to the large surface area thereof, the pulverized fine grains become coarse as a result of aggregating or redissolving and then recrystallizing around large crystals. In addition, if the circulation flow rate of the pump is excessively high, the coarsened grains end up being pulverized and forming fine crystals, thereby making it undesirable to indiscriminately increase the circulation flow rate. Accordingly, the circulation flow rate of the pump is preferably such that an amount of liquid equal to about 0.5 times to 4.0 times the amount of aqueous sodium hypochlorite solution in the crystallization tank, and more preferably an amount of liquid equal to about 1.0 time to 3.0 times the amount of aqueous sodium hypochlorite solution, is circulated in one hour.

In addition, in the case of stirring the inside of the crystallization tank during crystallization, the impeller tip speed is preferably 2.1 m/sec to 7.5 m/sec. As a result of selecting the impeller tip speed to be within this range, crystal scales adhered to the walls of the crystallization tank can be prevented and decomposition of sodium hypochlorite pentahydrate due to excessive generation of heat of crystallization can be suppressed by ensuring an adequate cooling rate, thereby making it possible to control crystal shape. Crystals having a high aspect ratio end up forming in the case of gentle stirring such that the impeller tip speed is 2.0 m/sec or less. In order to ensure an optimum balance among these factors, the impeller tip speed is particularly preferably 3.0 m/sec to 7.0 m/sec. In addition, the aforementioned stirring and pump circulation and stirring may be carried out simultaneously so that crystallization is carried out while stirring at an impeller tip speed of 2.1 m/sec to 7.5 m/sec while circulating at a pump circulation flow rate such that an amount of liquid equal to about 0.5 times to 4.0 times the amount of aqueous sodium hypochlorite solution in the crystallization tank is circulated in one hour.

The final temperature reached (cooling end temperature) in the crystallization step is preferably a temperature at which sodium hypochlorite pentahydrate precipitates but sodium chloride does not. More specifically, although varying according to the concentration of sodium chloride in the mother liquor, in the case of mother liquor containing about 4% to 8% of sodium chloride, the final temperature reached (cooling end temperature) in this step is preferably 0° C. to 16° C. This temperature makes it possible to maintain a suitable slurry concentration thereby facilitating solid-liquid separation of the subsequent step (fourth step). If the final temperature reached is excessively low, the amount of by-product sodium chloride crystals increases and the amount of energy required for cooling becomes excessive. On the other hand, if the cooling end temperature is excessively high, the amount of sodium hypochlorite pentahydrate formed is inadequate resulting in a decrease in production efficiency. Based on this balance, the cooling end temperature is more preferably 2° C. to 14° C. and even more preferably 4° C. to 12° C. In addition, although there are no particular limitations on crystallization time, in consideration of productivity, crystallization time is preferably within 12 hours and particularly preferably within 10 hours.

### Sodium Hypochlorite Pentahydrate Crystal Separation Step (Fourth Step)

In the separation step of the fourth step, the sodium hypochlorite pentahydrate obtained in the crystallization step is separated using a solid-liquid separation device such as a centrifuge to obtain sodium hypochlorite pentahydrate crystal grains.

Crystals of sodium hypochlorite pentahydrate that have been crystallized from the aqueous solution containing sodium hypochlorite pentahydrate cooled in the crystallization step are subjected to solid-liquid separation at a centrifugal effect of 1000 G to 3500 G using continuous or batch type centrifuge. The crystal surfaces may be washed with a solution containing water and inorganic materials as necessary to treat the surface and allow the obtaining of sodium hypochlorite pentahydrate crystal grains.

### EXAMPLES

Although the following provides a more detailed explanation of the present invention through examples thereof, the present invention is not limited thereto. Furthermore, unless specifically indicated otherwise, the term “%” refers to percent (%) by mass in the following examples and comparative examples.

### Example 1 (Invention Example)

A two-stage continuous stirred tank reactor (CSTR) (volume: 3.5 m³×2 tanks) provided with a stirrer, scrubber and external circulating condenser was used in the chlorination step (first step). Raw material in the form of 48% by mass aqueous sodium hydroxide solution was added thereto at 860 kg/hr together with introducing chlorine gas diluted to 1/2 the undiluted concentration with air using the scrubber while adjusting the supplied amount so that the sodium. chloride concentration in the residual water was 2% by mass followed by carrying out chlorination while cooling so that the reaction temperature was 24° C. to 30° C. At this time, the retention time in the reaction tanks was about 720 minutes.

In the sodium chloride separation step (second step), reactant slurry extracted from the reaction tanks of the chlorination step at 1188 kg/hr was subjected to solid-liquid separation with a centrifuge. As a result, precipitated sodium chloride was obtained at the rate of 254 kg/hr and aqueous sodium hypochlorite solution (Filtrate 1), comprised of sodium hypochlorite having a concentration of 35% by mass and sodium chloride having a concentration of 5.4% by mass, was obtained at the rate of 934 kg/hr.

Soft water was added to Filtrate 1 to adjust the sodium hypochlorite concentration to 31.9% by mass, the sodium chloride concentration to 4.9% by mass, and the sodium hydroxide concentration to 1.5% by mass.

In the crystallization step (third step), 8942 kg of the aforementioned Filtrate 1 were added to a titanium crystallization tank (volume: 7 m³) provided with a stirrer, jacket, coil condenser and external circulation pump while adjusting the temperature to 22° C., and at this time, cooling was started so that the temperature difference ° ΔT between the temperature of the Filtrate 1 and the coolant temperature was 3° C. to 4° C. while circulating at the rate of 1.5 times/hr using a volute pump and stirring at an impeller tip speed of 4.5 m/sec using a stirrer, followed by cooling to 12° C. over the course of 4 hours. Crystal formation was observed in the crystallization tank starting at a temperature of 19° C.

In the separation step (fourth step), the slurry extracted from the circulation tank of the circulation step (third step) was subjected to liquid-solid separation with a centrifuge at 1500 G while holding the temperature in the crystallization tank to 14° C. As a result, 2850 kg of highly pure sodium hypochlorite pentahydrate crystals were obtained. The composition and properties of the resulting sodium hypochlorite pentahydrate crystal grains are shown in Table 1. The average aspect ratio was 1.65.

The distribution of the aspect ratios of the resulting sodium hypochlorite pentahydrate is shown in FIG. 6.

### Example 2 (Invention Example)

The same procedures as the chlorination step (first step) and sodium chloride separ atio step (second step) of Example 1 were carried out to obtain Filtrate 2 having a sodium hypochlorite concentration of 32.2% by mass, sodium chloride concentration of 5.1% by mass, and sodium hydroxide concentration of 1.3% by mass.

In the crystallization step (third step), 8781 kg of the aforementioned Filtrate 2 were added to a titanium crystallization tank (volume: 7 m³) provided with a stirrer, jacket, coil condenser and external circulation pump while adjusting the temperature to 22° C., and at this time, cooling was started so that the temperature difference ° ΔT between the temperature of the Filtrate 2 and the coolant temperature was 3° C. to 4° C. while stirring at an impeller tip speed of 7.5 m/sec using a stirrer, followed by cooling to 12° C. over the course of 4 hours. Crystal formation was observed in the crystallization tank starting at a temperature of 17° C.

In the separation step (fourth step), the slurry extracted from the circulation tank of the circulation step (third step) was subjected to liquid-solid separation with a centrifuge at 1500 G while holding the temperature in the crystallization tank to 14° C. As a result, 2790 kg of highly pure sodium hypochlorite pentahydrate crystals were obtained. The composition and properties of the resulting sodium hypochlorite pentahydrate crystal grains are shown in Table 1. The average aspect ratio was 2.16.

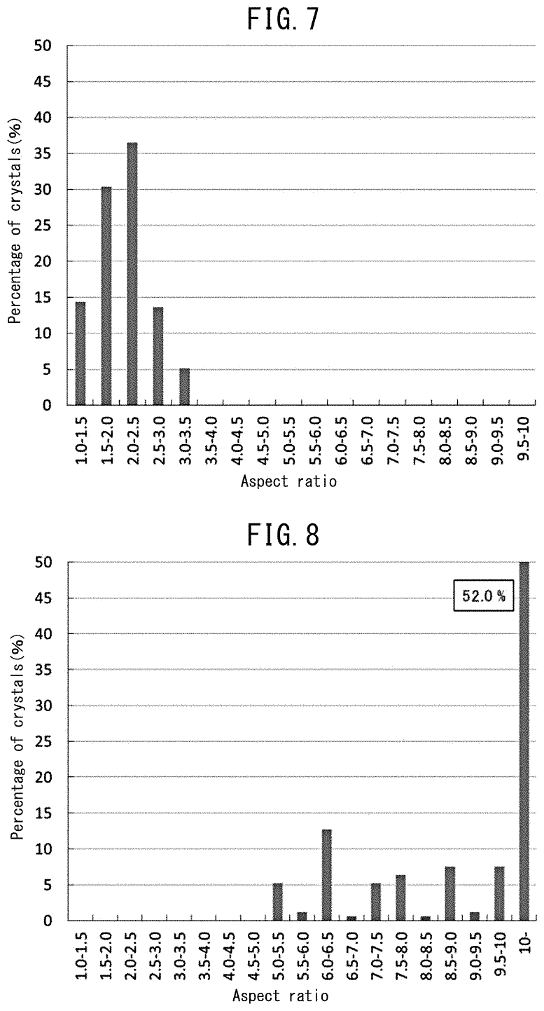

The distribution of the aspect ratios of the resulting sodium hypochlorite pentahydrate is shown in FIG. 7.

### Comparative Example 1

A comparative example was examined in which the stirring speed was decreased and without carrying out circulation in the third step in order to confirm the effects of circulation and stirring.

The aqueous sodium hypochlorite solution of Table 1 obtained in the same manner as Example 1 by chlorinating sodium hydroxide in the first step followed by going through the second step was cooled starting at 22° C. (cooling starting temperature) over the course of 240 minutes while stirring at an impeller tip speed of 2.0 m/sec but not circulating until the temperature (cooling end temperature) reached 12° C. (third step) followed by filtering the resulting sodium hypochlorite pentahydrate crystals by centrifuging at 500 G to obtain sodium hypochlorite pentahydrate crystal grains (fourth step). The properties of the resulting sodium hypochlorite pentahydrate are shown in Table 1. The composition and properties of the resulting hypochlorite pentahydrate crystal grains are shown in Table 1. The average aspect ratio was 9.51.

The distribution of the aspect ratios of the resulting sodium hypochlorite pentahydrate crystal grains are shown in FIG. 8. Crystals having an aspect ratio of 9.0 or more accounted for 60% of all crystals and narrow needle crystals were obtained.

### Comparative Example 2

Aspect ratio and bulk density were measured using solid type sodium hypochlorite pentahydrate manufactured by Nacalai Tesque, Inc. (product code: 15591-65). The composition and properties thereof are shown in Table 1. The average aspect ratio was 4.29.

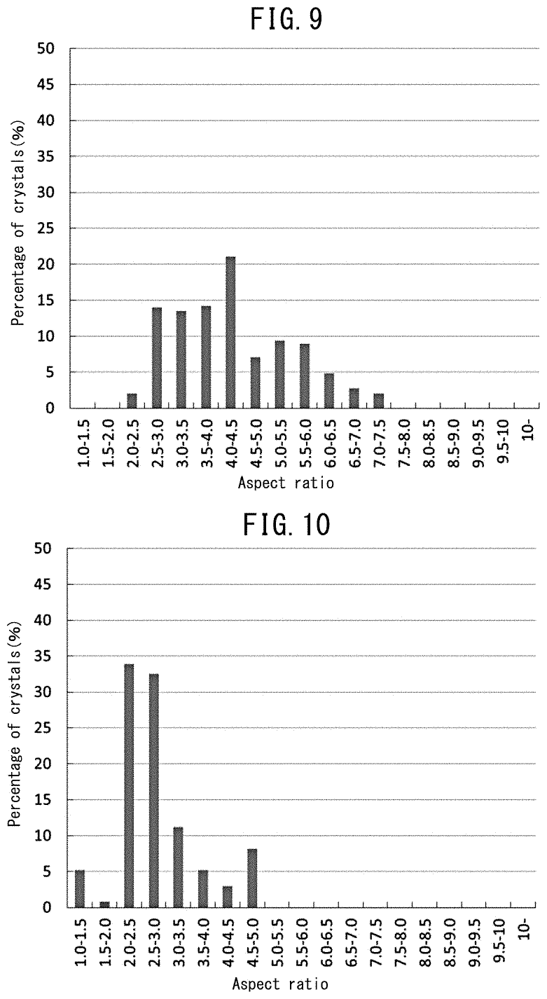

The distribution of the aspect ratios of the sodium hypochlorite pentahydrate crystals of Comparative Example 2 are shown in FIG. 9. Narrow needle crystals were obtained in which the aspect ratios were distributed over a range of 2.5 to 6.0.

### Comparative Example 3

Aspect ratio and bulk density were measured using sodium hypochlorite pentahydrate available from Wako Pure Chemical industries, Ltd. (specifications: Wako grade 1, code no.: 199-171215). The composition and properties thereof are shown in Table 1. The average aspect ratio was 2.81.

The distribution of the aspect ratios of the resulting sodium hypochlorite pentahydrate crystals are shown in FIG. 10. Needle-like crystals were obtained in which crystals having an aspect ratio over the range of 2.0 to 3.0 accounted for 60% of all crystals.

TABLE 1

| | Example 1 | Example 2 | Comp. Ex. 1 | Comp. Ex. 2 | Comp. Ex. 3 |
|---|---|---|---|---|---|
| NaOCl concentration (wt %) | 44.1 | 43.9 | 44.7 | 43.6 | 44.3 |
| NaCl concentration (wt %) | 0.12 | 0.10 | 0.10 | 1.7 | 0.13 |
| NaOH concentration (wt %) | 0.06 | 0.08 | 0.08 | 0.5 | 0.05 |
| NaClO₃ concentration (wt %) | 0.05 | 0.02 | 0.05 | 0.2 | 0.05 |
| Average aspect ratio | 1.65 | 2.16 | 9.51 | 4.29 | 2.81 |
| Average minor axis (mm) | 0.4 | 0.3 | 0.3 | 0.7 | 0.6 |
| Bulk density (g/cm³) | 0.97 | 0.84 | 0.57 | 0.76 | 0.79 |
| Angle of repose (°) | 54 | 53 | 53 | 41 | 54 |
| Shape | Spherical | Spherical | Narrow | Wide | Wide |
| | aggregate | aggregate | needles | needles | needles |

### INDUSTRIAL APPLICABILITY

As is clear from the above results, the sodium hypochlorite pentahydrate of the present invention allows the obtaining of rounded sodium hypochlorite pentahydrate crystal grains that have a low aspect ratio and demonstrate significantly improved bulk density in comparison with conventional production methods. Improvement of transport efficiency and reduction in the number of containers and the like can be achieved in comparison with conventional products by decreasing volume during transport.

1. Sodium hypochlorite pentahydrate crystal grains having an average aspect ratio of 2.5 or less and an average minor axis of 0.1 mm to 1.5 mm.

2. The sodium hypochlorite pentahydrate crystal grains according to claim 1, wherein bulk density is 0.80 g/cm³ or more.

3. Sodium hypochlorite pentahydrate crystal grains having a bulk density of 0.80 g/cm³ or more.

4. A method for producing sodium hypochlorite pentahydrate crystal grains, comprising:
a first step for introducing chlorine into a 40% by mass to 48% by mass aqueous sodium hydroxide solution and chlorinating at a reaction temperature of 15° C. to 32° C.;
a second step for separating and removing by-product sodium chloride crystals that have precipitated and recovering an aqueous sodium hypochlorite solution having a sodium hypochlorite concentration of 24% by mass to 34% by mass;
a third step for cooling the aqueous solution containing sodium hypochlorite pentahydrate recovered in the second step to a cooling temperature of 0° C. to 26° C. in a crystallization tank integrating a condenser and a crystallizer to precipitate sodium hypochlorite pentahydrate crystals, wherein the aqueous solution in the tank is stirred or circulated with a pump or stirred and circulated with a pump; and,
a fourth step for liquid-solid separating of the sodium hypochlorite pentahydrate crystals precipitated in the third step to obtain sodium hypochlorite pentahydrate crystal grains.

5. The production method according to claim 4, wherein the stirring in the third step is carried out at an impeller tip speed of 2.1 m/sec to 7.5 m/sec.

6. The production method according to claim 4, wherein the pump circulation in the third step is carried out by circulating an amount of liquid equal to 0.5 times to 4 times the amount of aqueous solution in the crystallization tank in one hour.

7. The production method according to claim 4, wherein the pump circulation in the third step is carried out by circulating an amount of liquid equal to 0.5 times to 4 times the amount of aqueous solution in the circulation tank in one hour and stirring at an impeller tip speed of 2.1 m/sec to 7.5 m/sec.
